(19) United States
(12) Patent Application Publication
(10) Pub. No.: US 2003/0126088 A1
(43) Pub. Date: Jul. 3, 2003

(54) Computer program storage medium, client computer, server, content distributing system and content distributing method

(75) Inventor: Toru Mineyama, Kanagawa (JP)

Correspondence Address: LERNER, DAVID, LITTENBERG,, KRUMHOLZ & MENTLIK, 600 SOUTH AVENUE WEST, WESTFIELD, NJ, 07090, US

(73) Assignee: Sony Corporation, Tokyo (JP)

(21) Appl. No.: 10/319,306

(22) Filed: Dec. 13, 2002

(30) Foreign Application Priority Data
Dec. 14, 2001 (JP) P2001-381572

(51) Int. Cl. G06F 17/60

(52) U.S. Cl. 705/51

(57) ABSTRACT

A computer program, a recording medium, a client computer, a server, a content distributing system and a content distributing method are provided in which, when a user downloads a desired content, the user is not required to set the download time of the content by himself/herself. A user terminal displays a list of available contents from which a user may select a desired content, and transmits property information containing the address of a content server for supplying the selected content and the access time for the content server from an authenticating server to the user terminal. An access to the content server is made from the user terminal at a prescribed time based on the property information to download the selected content to the user terminal.

### CROSS-REFERENCE TO RELATED APPLICATIONS

The present application claims priority from Japanese Application No. 2001-381572 filed on Dec. 14, 2001, the disclosure of which is hereby incorporated by reference herein.

### BACKGROUND OF THE INVENTION

The present invention relates to a computer program, a recording medium, a server, a content distributing system and a content distributing method which enable a client computer to download a prescribed content at a prescribed time, and a client computer which can download a prescribed content at a prescribed time.

Automatic cyclic software is known as software for automatically downloading a desired web page from a prescribed server. The automatic cyclic software is connected to the prescribed server at a cyclic period set by a user to download the desired web page.

In the conventional automatic cyclic software, since the cyclic period is required to be set by a user himself/herself, there have occurred situations in which the cyclic period is not coincident with the renewing times of the web page and thus the automatic cyclic software connects to the web page at many times even when the web page has not been renewed or downloads a web page after the web page has been renewed many times and therefore misses necessary information.

### SUMMARY OF THE INVENTION

The present invention has been implemented in view of the foregoing situation, and has an object to provide a computer program, a recording medium, a client computer, a server, a content distributing system and a content distributing method in which, when a user downloads a desired content, it is unnecessary for the user to set the time of the download by himself/herself.

In order to attain the above object, according to a first aspect of the present invention, there is provided a recording medium recorded with a program for downloading content. The program includes displaying a list of usable contents from which a user may select a desired content; retrieving from a prescribed computer property information including an address (IP (Internet Protocol) address, URL (Uniform Resource Locator) or the like) of a content server for supplying the selected content and an access time for the content server; accessing the content server at a prescribed time based on the property information to download the selected content; and informing the user that the selected content has been downloaded.

According to a second aspect of the present invention, there is provided a client computer, including means for displaying a list of usable contents from which a user may select a desired content; means for retrieving from a prescribed computer property information including an address of a content server for supplying the selected content and an access time for the content server; means for accessing the content server at a prescribed time based on the property information to download the selected content; and means for informing the user that the selected content has been downloaded.

For example, a server computer, a host computer, a personal computer or the like may be used as the “prescribed computer” from which the property information is retrieved, however, the present invention is not limited to these computers.

The “computer” or “client computer” which are made to implement the above functions by the program may include a device which can be connected to a network, such as a personal computer which can be connected to a network, such as the Internet or the like; a mobile telephone terminal, such as a cellular phone terminal, PHS (Personal Handy Phone System) or the like; a mobile information terminal, such as a PDA (Personal Digital Assistance) or the like; a game machine; etc.

According to the present invention, the information on the download of the contents can be set in detail for every content based based on the property information. The user can automatically retrieve the desired content based on the property information, and thus it is unnecessary for the user himself/herself to set the time of the download, etc. Further, a content supplier can set the time of the download at its convenience. Therefore, it is possible to prevent concentrated access to the content server and downloading before the contents have been renewed.

The program may further include retrieving authentication information from the prescribed computer; and transmitting the retrieved authentication information when the content server is accessed at the prescribed time.

The client computer may be equipped with means for retrieving the authentication information from the prescribed computer; and means for transmitting the retrieved authentication information when the content server is accessed at the prescribed time.

The “authentication information” may be a unique content using key successively generated, or a user ID and a password which are continuously usable.

When the authentication information is retrieved from the prescribed computer, user identification information is transmitted to the prescribed computer, and the authentication information is retrieved after authentication.

According to this invention, the content server enables the user to download the selected content based on the authentication information, so that a user retrieving no authentication information (unauthorized user) can be prevented from improperly downloading the content.

In the program, the property information may include an expiration date of the property information, and program may further include determining whether the expiration date of the property information has passed; and informing the user that the property information has expired when it is determined that the expiration date of the property information has passed.

In the client computer, the property information may include the expiration date of the property information, and the client computer may further include means for determining whether the expiration date of the property information has passed, and for informing the user that the property information has expired when it is determined that the expiration date of the property information has passed.

According to this invention, the management of the term of validity (hereinafter referred to as “term management”) for property information having an expiration date can be facilitated.

In the program, the selected content may include an expiration date of the selected content, and the program may further include determining whether the expiration date of the selected content has passed; and informing the user that the selected content has expired when it is determined that the expiration date of the selected content has passed.

In the client computer, the selected content may include the expiration date of the selected content, and the client computer may further include means for determining whether the expiration date of the selected content has passed, and for informing the user that the selected content has expired when it is determined that the expiration date of the selected content has passed.

According to this invention, the term management of selected content having an expiration date can be facilitated.

In the program, the content may include an address of another server for supplying software needed to display the selected content, and the program may further include accessing the address of the another server and downloading the software.

In the client computer, the selected content may include the address of the another server for supplying the software needed to display the selected content, and the client computer may further include means for determining whether the software needed to display the selected content exists in the client computer; and means for accessing the address of the another server and for downloading the software if it is determined that the software does not exist in the client computer.

According to this invention, even when the software needed to display the selected content is not immediately available to the user, the software can be automatically retrieved, and thus the downloaded content can be displayed.

The program may include storing a download time (date and hour, day, date or the like) when the selected content has been downloaded; and transmitting information on a previous download time of the selected content when the content server is accessed at the prescribed time.

The client computer may further include means for storing the download time when the selected content has been downloaded; and means for transmitting information on a previous download time of the selected content when the content server is accessed at the prescribed time.

According to this invention, the content server can select the content to be transmitted based on the previous download time received even when it has plural contents renewed on different days, so that the user can be prevented from duplicatively downloading a past-downloaded content.

The types of “recording medium” on which the programs may be recorded include a magnetic medium (hard disk, magnetic disk, floppy disk, magnetic tape, magnetic card, etc.), an optical medium (an optical disc such as compact disc, DVD (Digital Versatile Disc), laser disc or the like), a magnetooptical medium (a magnetooptical disc such as an MO (Magnet Optical) disc or the like), or various types of memories. However, the recording medium is not limited to any special type.

According to a third aspect of the present invention, there is provided a server including means for storing property information associated with each of a plurality of contents, the property information including an address of a content server for supplying the respective contents and an access time for the content server; and means for transmitting to a client computer the property information associated with a specified one of the plurality of contents requested by the client computer.

According to this aspect of the invention, the content-download information can be set in detail for every content based on the property information. Since the user of the client computer can automatically retrieve a desired content based on the property information, it is unnecessary for the user to set the time of the download, etc. by himself/herself. Furthermore, since a content supplier can set the time of the download at its convenience, concentrated access to the content server can be prevented, and the downloading of a content before it has been renewed can be prevented.

The server may further include means for generating and holding authentication information; means for transmitting the generated authentication information to the client computer; and means for receiving second authentication information from the content server and for performing an authentication process based on the second authentication information.

According to this invention, the content server allows the download of a content based on an authentication process which is carried out based on the authentication information received by the server from the client computer. Therefore, the content can be prevented from being improperly downloaded by a user retrieving no authentication information (unauthorized user).

The server may further include means for storing, in association with user identification information, identification information for a user-usable content relating to the user identification information.

According to this invention, authentication to use contents, charging for use of the contents and management of usable contents can be performed based on the user identification information.

The server may store the program for downloading content so that the program can be downloaded.

According to this invention, the user can retrieve both software and property information relating to the program by merely accessing a single server (group).

According to a fourth aspect of the invention, there is provided a server including means for receiving authentication information when a request for a specified content is received from a client computer; means for transmitting the received authentication information to a prescribed computer and for receiving a result of an authentication process carried out in the prescribed computer; and means for transmitting the specified content to the client computer only when the result of the authentication process indicates authenticity.

According to this invention, a specified content can be downloaded based on an authentication process which is carried out based on authentication information received by a prescribed computer from a client computer, so that the specified content can be prevented from being improperly downloaded by a user having no authentication information (unauthorized user).

According to a fifth aspect of the present invention, there is provided a server including means for receiving a request for a specified content from a client computer; and means for transmitting to the client computer an address of another server for supplying software needed to display the specified content together with the specified content.

According to this invention, even when the client computer does not have the software needed to display the specified content, the client computer can access the address received from the another server to easily retrieve the software.

According to a sixth aspect of the present invention, there is provided a server including means for receiving information on a previous download time of a specified content when a request for the specified content is received from a client computer; means for selecting a content to be transmitted to the client computer based on the information on the previous download time; and means for transmitting the selected content to the client computer.

According to this invention, even when the server has plural contents renewed on different days, the server can select a content to be transmitted based on the previous download time, so that the server can prevent a user from duplicatively downloading a past-downloaded content.

According to a seventh aspect of the present invention, there is provided a content distributing system including a client computer; a server; and a communication network for connecting the client computer to the server. The client computer may include means for displaying a list of useful contents from which a user may select a desired content; means for retrieving from the server property information including an address of a content server for supplying the selected content and an access time for the content server; means for accessing the content server at a prescribed time based on the property information to download the selected content; and means for informing the user that the selected content has been downloaded. The server may include means for storing property information associated with each of the contents; and means for transmitting to the client computer the property information associated with the selected content.

The content distributing system may further include any of the servers described above.

According to an eighth aspect of the present invention, there is provided a method of distributing a content from a content server through a communication network to a client computer, including displaying a list of usable contents at the client computer from which a user may select a desired content; transmitting property information from a prescribed computer (may be the content server) to the client computer, the property information including an address of the content server for supplying the selected content and an access time for the content server; and accessing the content server at a prescribed time based on the property information and downloading the selected content to the client computer.

According to this invention, the information on the download of contents can be set in detail for every content based on the property information. The user of the client computer can automatically retrieve the selected content based on the property information, and thus the user is not required to set the time of the download, etc. by himself/herself. Furthermore, a content supplier can set the time of the download at its convenience, so that concentrated access to the content server and downloading of a content before the content has been renewed can be prevented.

The content distributing method may further include generating and storing authentication information in the prescribed computer (may be the prescribed computer described above); transmitting the generated authentication information from the prescribed computer to the client computer; transmitting the authentication information received at the client computer from the client computer to the content server; transmitting the authentication information received at the content server from the content server to the prescribed computer; performing an authentication process based on the authentication information received at the prescribed computer to obtain an authentication result; transmitting the authentication result from the prescribed computer to the content server; and transmitting the selected content from the content server to the client computer based on the authentication result.

The “authentication information received at the client computer” may be transmitted when a download request is made from the client computer to the content server.

According to this invention, the content server can download the selected content based on the authentication process which is carried out on the basis of the authentication information received from the client computer by the prescribed computer, so that the content can be prevented from being improperly downloaded by a user who cannot retrieve authentication information (unauthorized user).

In the content distributing method, the property information may further include an expiration date of the property information, and the content distributing method may further include determining whether the expiration date of the property information has passed; and informing the user that the property information has expired when it is determined that the expiration date of the property information has passed.

According to this invention, the term management of property information having an expiration date can be facilitated.

In the content distributing method, the selected content may include an expiration date of the selected content, and the content distributing method may further include determining whether the expiration date of the selected content has passed, and informing the user that the selected content has expired when it is determined that the expiration date of the selected content has passed.

According to this invention, the term management of content having an expiration date can be facilitated.

In the content distributing method, the selected content may include an address of another server for supplying software needed to display the selected content, and the content distributing method may further include determining whether the software needed to display the selected content exists in the client computer; and accessing the address of the another server and downloading the software if it is determined that the software does not exist in the client computer.

According to this invention, even when the client computer is not provided with the software needed to display the selected content, the client computer can easily retrieve the software by accessing the address contained in the selected content.

The content distributing method may further include storing a download time of the selected content in the client computer; transmitting information on the stored download time from the client computer to the content server; identifying a content to be transmitted to the client computer based on the information on the stored download time received in the content server; and transmitting the identified content to the client computer.

The “information on the stored download time” may be transmitted when a download request is made from a client computer to a content server.

According to this invention, even when the content server has plural contents renewed on different days, the content server can select a content to be transmitted on the basis of the received information on a previous download time, so that a user can be prevented from duplicatively downloading a content which was downloaded previously by the user.

### BRIEF DESCRIPTION OF THE DRAWINGS

FIG. 1 is a diagram showing a content distributing system according to an embodiment of the present invention;

FIG. 2 is a diagram showing an authenticating server according to the embodiment;

FIG. 3 is a flowchart showing the processing operation of the authenticating server and a user terminal according to the embodiment;

FIG. 4 is a flowchart showing the processing operation of the authenticating server and the user terminal according to the embodiment;

FIG. 5 is a flowchart showing the processing operation of the authenticating server, a content server and the user terminal according to the embodiment;

FIG. 6 is a flowchart showing the processing operation of the authenticating server, the content server and the user terminal according to the embodiment;

FIG. 7 is a flowchart showing the processing operation of the authenticating server, the content server and the user terminal according to the embodiment;

FIG. 8 is a flowchart showing the processing operation of the authenticating server, the content server and the user terminal according to the embodiment;

FIG. 9 is a diagram showing an example of a usable content list screen of the embodiment;

FIG. 10 is a diagram showing an example of a subscribed content list screen according to the embodiment; and

FIG. 11 is a diagram showing an example of a downloaded content list screen according to the embodiment.

### DETAILED DESCRIPTION

Preferred embodiments according to the present invention will be described herein with reference to the accompanying drawings.

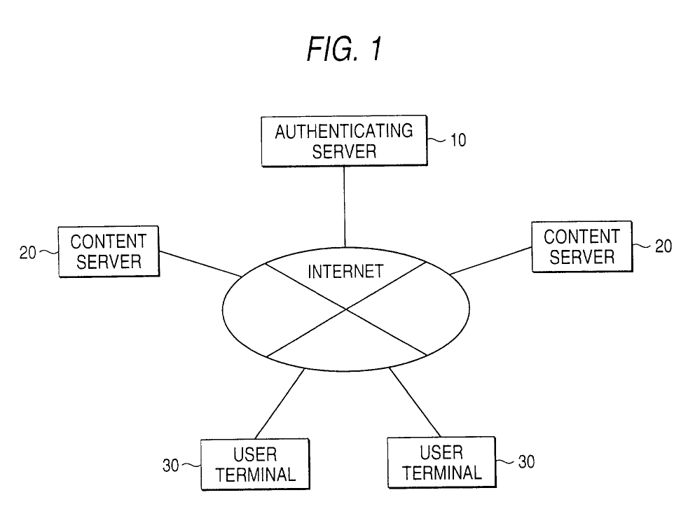

FIG. 1 is a diagram showing the construction of a content distributing system according to an embodiment of the present invention. The content distributing system according to this embodiment mainly relates to a system for distributing electronic publications as content, however, the present invention is not limited to such a content distributing system.

As shown in FIG. 1, the content distributing system according to this embodiment includes an authenticating server 10, plural content servers 20 and plural user terminals 30 which are connected to one another through the Internet.

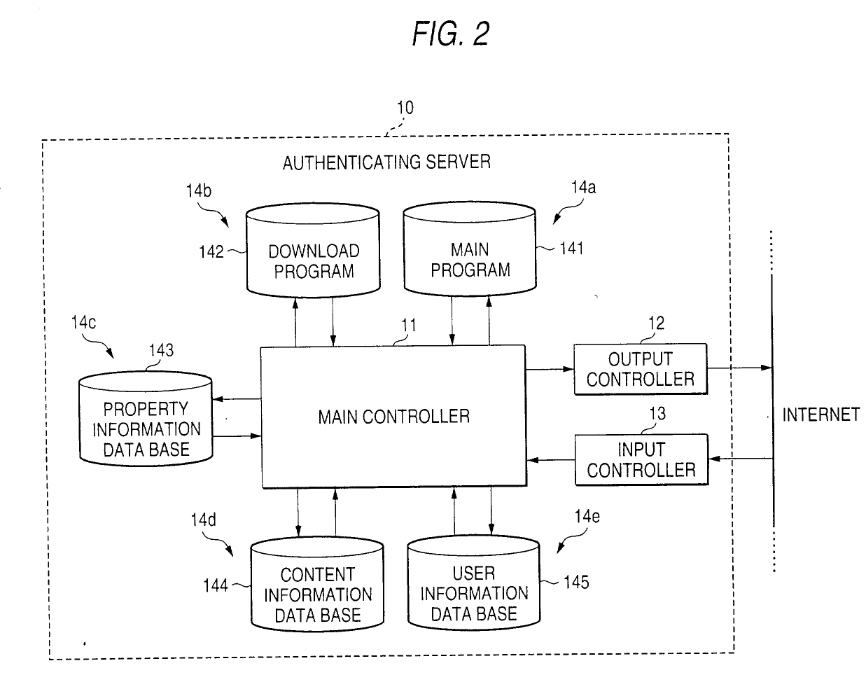

FIG. 2 shows the main construction of the authenticating server 10. The authenticating server 10 includes a main controller 11, an output controller 12, an input controller 13, a first storage device 14a, a second storage device 14b, a third storage device 14c, a fourth storage device 14d and a fifth storage device 14e.

The main controller 11 includes a CPU, a main storage device (memory), etc., and performs control of various parts, data transfer, various operations, temporary storage of data, etc. The output controller 12 controls data output from the authenticating server 10, and the input controller 13 controls data input to the authenticating server 10.

Each of the first to fourth storage devices 14a to 14e comprises a storage device, such as a hard disc or the like (or a disc or storage area serving as a part of the storage device). Main programs 141 are stored in the first storage device 14a, an application program 142 for download is stored in the second storage device 14b, a property information database 143 is constructed in the third storage device 14c, a content information database 144 is constructed in the fourth storage device 14d, and a user information database 145 is constructed in the fifth storage device 14e.

The main programs 141 contain a program for performing authentication on an access from a client and permitting log-in of the client; a program for enabling a client to download an application program in response to a request from the client; a program for displaying a content list in response to a request from a client; a program for receiving the content ID of a content selected by a client, transmitting the corresponding property information to the client and storing the content ID concerned in connection with the user ID; a program for performing authentication on download in response to a request from a client, generating/storing a unique content using key and transmitting the content using key thus generated to the client concerned; a program for performing authentication on a content using key in response to a request from a content server 20; etc.

The application program 142 for download is software for enabling a client to implement a function of holding, transmitting and checking user IDs and passwords; a function of requesting a content list from the authenticating server 10 and displaying the content list received (available content list, subscribed content list); a function of transmitting the content ID of a content selected by a user and receiving property information associated with the content ID concerned; a function of determining whether the user ID contained in the property information received is truly owned by the user concerned, and setting the software on the basis of the received property information if it is truly owned by the user concerned; a function of determining whether the expiration date of the property information has passed and displaying an alarm if the property information has expired, a function of determining whether the present time is an access time to the content server 20, accessing the authenticating server 10 to request authentication and achieve a content using key if the present time is the access time, and then accessing a prescribed content server 20 with the content using key to request download of the content; a function of receiving a content from the content server 20, determining whether the download size of the content thus received is correct, whether the content thus received is suitable for the user concerned, and whether the content detailed ID of the content thus received is new, adding the title of the content to a download list and displaying newly-arrived information together with the download list if it is determined that the download size is correct, the content received is suitable for the user concerned and the content detailed ID is new; a function of determining whether the expiration date of the content has passed and displaying an alarm if the content has expired; a function of determining whether there is any viewer for the content selected by the user, starting the viewer to display the content if a viewer exists or downloading and installing a viewer from a prescribed server and then starting the viewer thus downloaded to display the content if no viewer exists, and deleting the newly-arrived information, etc.

Property information of each content is stored in connection with the content ID of the content in the property information database 143. The property information contains information on the IP address of the content server 20 serving as the content supply source, the access time to the content server 20, the expiration date of the property information concerned and a content publisher. The property information is automatically or manually created on the basis of information transmitted from the content publisher.

With respect to the access time to the content server 20 contained in the property information, it is preferable that some time lag be set in the access time among property information pieces so as to prevent a concentration of accesses from many user terminals 30 to the content server 20. Such access time may be set by using random numbers.

Publishing sources, titles, issuance dates, subscription terms, prices, lists of contents, etc. for respective contents usable by users are respectively stored in connection with the content IDs in the content information database 144.

In the user information database 145 are stored the user IDs, passwords and charging information (for example, credit card numbers, etc.) of users, the content IDs of contents subscribed by the users concerned and the subscription terms.

In this embodiment, the authenticating server 10 consists of one server machine, however, it may consist of plural server machines (for example, WWW machine, download server, database server, application server, etc.).

Although the construction of the content server 20 is not shown in detail, the content server 20 is equipped with a program for requesting an acknowledgement on a content using key from the authenticating server 10 when a download request containing information on the content using key concerned is made to the content server 20, and for transmitting the content if the acknowledgement is positive. The content server 20 stores contents to be supplied therefrom so that viewer data for displaying these contents at clients can be downloaded.

The user terminal 30 is a device which can be connected to the Internet, and in the following description, it is assumed that the user terminal 30 is a normal personal computer equipped with a keyboard and a mouse as input devices, and that it can be connected to the Internet. The user terminal 30 has a function of accessing a desired server through the Internet, downloading a desired application program and installing software relating to the application program.

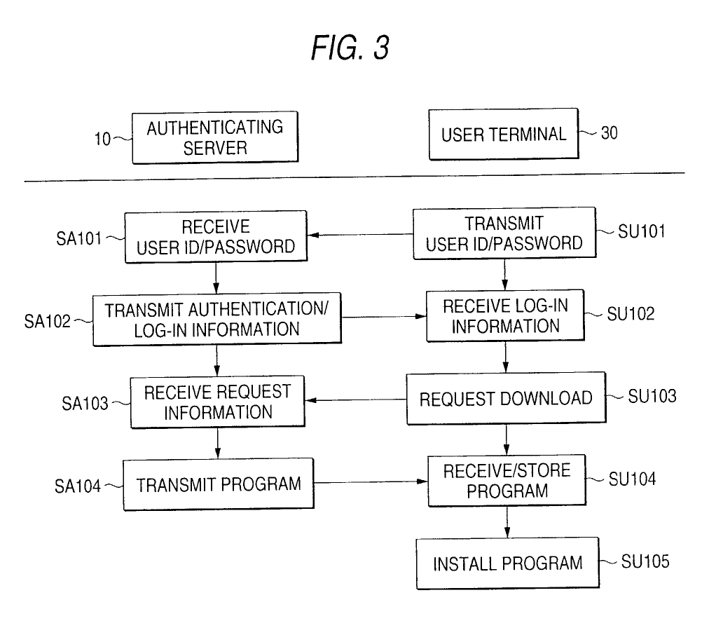

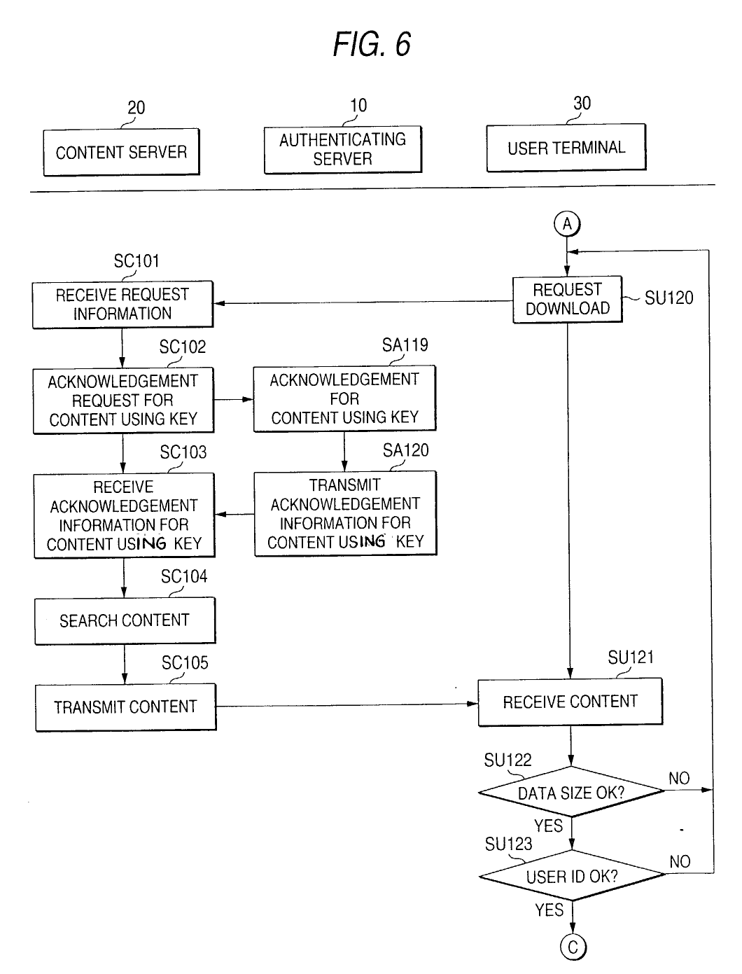

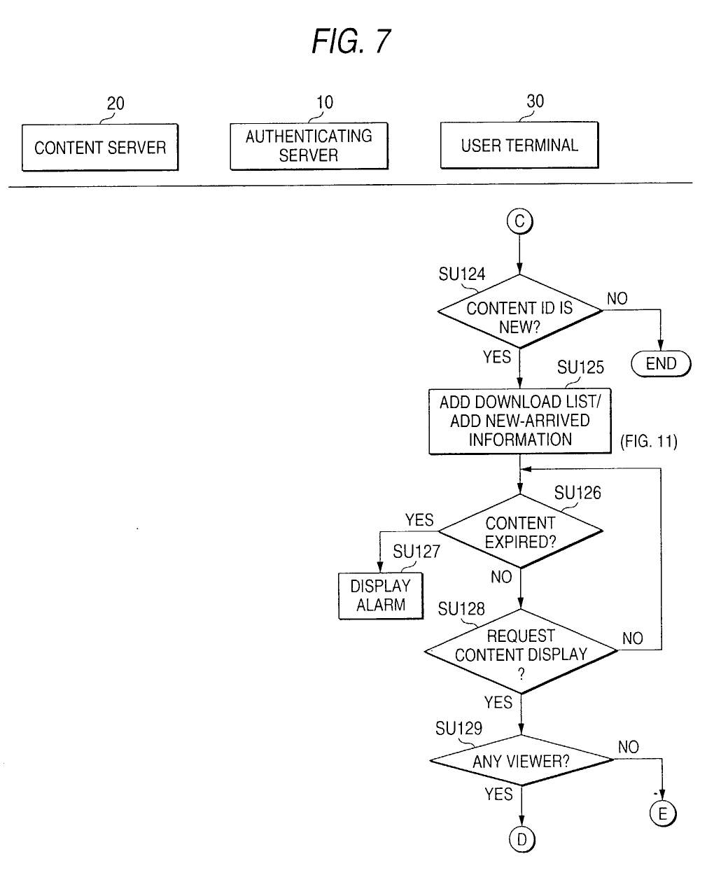

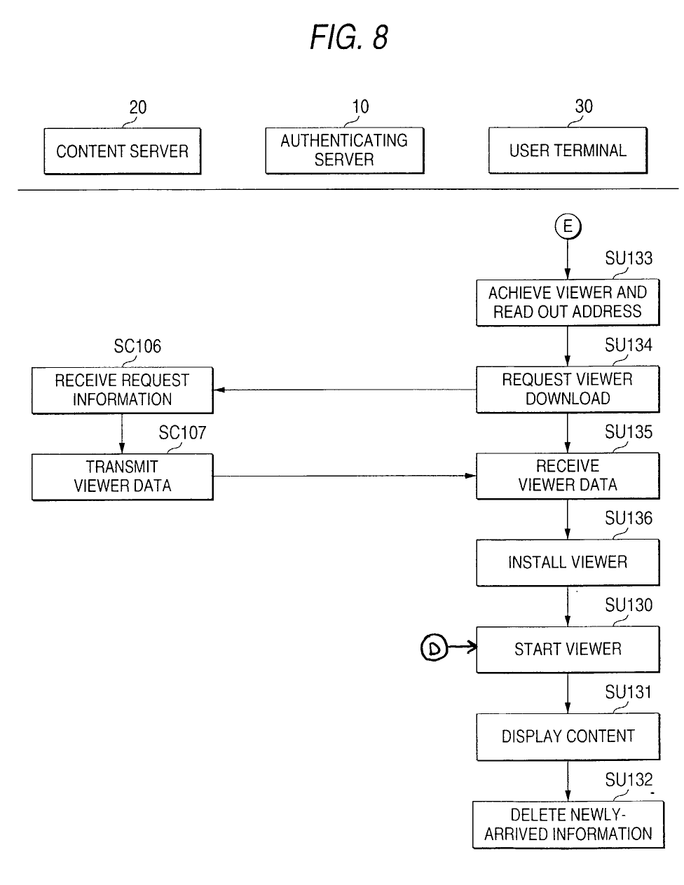

Next, the processing operation of the authenticating server 10, the content server 20 and the user terminal 30 in the content distributing system will be described with reference to the flowcharts of FIGS. 3 to 8.

First, the processing operation of the authenticating server 10 and the user terminal 30 when the application program 142 is downloaded will be described (FIG. 3). In this case, it is assumed that a user has already completed user registration in the authenticating server 10 and has been provided with a user ID and a password, and that the user ID and the password have been stored in the user information database 145 of the authenticating server 10.

When the user accesses the authenticating server 10 through the Internet from the user terminal 30 to input/transmit the user ID and the password (SU101), the main controller 11 of the authenticating server 10 receives the user ID and the password thus transmitted (SA101). Thereafter, the main controller 11 of the authenticating server 10 refers to the user information database 145 to determine whether the user ID and the password thus received are correct. If the main controller 11 determines that they are correct, the main controller 11 transmits log-in information to the user terminal 30 (SA102) for allowing log-in.

When the user requests to download the application program 142 after the user terminal 30 has received the log-in information (SU102), the user terminal 30 transmits the download request information for the application program to the authenticating server 10 (SU103). The main controller 11 of the authenticating server 10 receives the download request information (SA103), and transmits the application program 142 to the user terminal 30 (SA104).

The user terminal 30 receives/stores (downloads) the application program 142 thus transmitted (SU104), and installs the software relating to the application program 142 (hereinafter referred to as “content managing software”) (SU105). It is assumed that the content managing software holds a user ID and a password needed to access the authenticating server 10 at the install time.

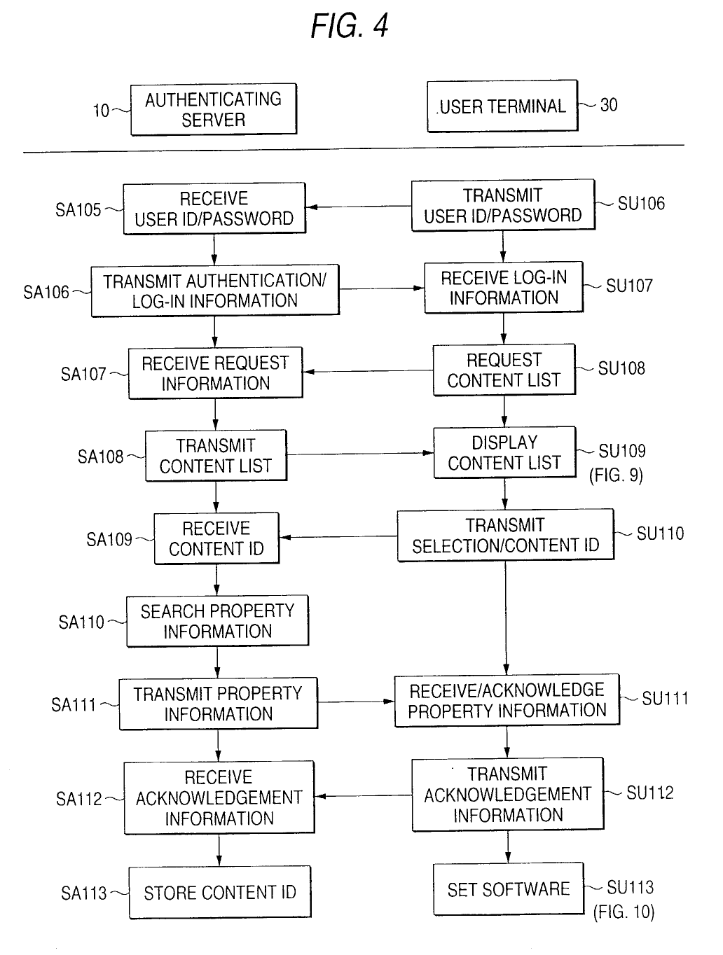

Next, the processing operation of the authenticating server 10 and the user terminal 30 when property information is achieved will be described (FIG. 4).

When the user starts the content managing software installed in the user terminal 30 and requests log-in to the authenticating server 10 through the Internet from the content managing software, the user terminal 30 transmits the stored user ID and password to the authenticating server 10 (SU106). The main controller 11 of the authenticating server 10 receives the user ID and the password thus transmitted (SA105), and refers to the user information database 145 to determine whether the user ID and password thus received are correct. If it is determined that they are correct, the main controller 11 transmits the log-in information to the user terminal 30 (SA106) for allowing log-in.

When the user requests a content list corresponding to a list of available contents after the user terminal 30 has received the log-in information (SU107), the user terminal 30 transmits the content list request information to the authenticating server 10 (SU108). The main controller 11 of the authenticating server 10 receives the content list request information (SA107), generates the screen data of the content list read out from the content information database 144, and transmits the screen data thus generated to the user terminal 30 (SA108).

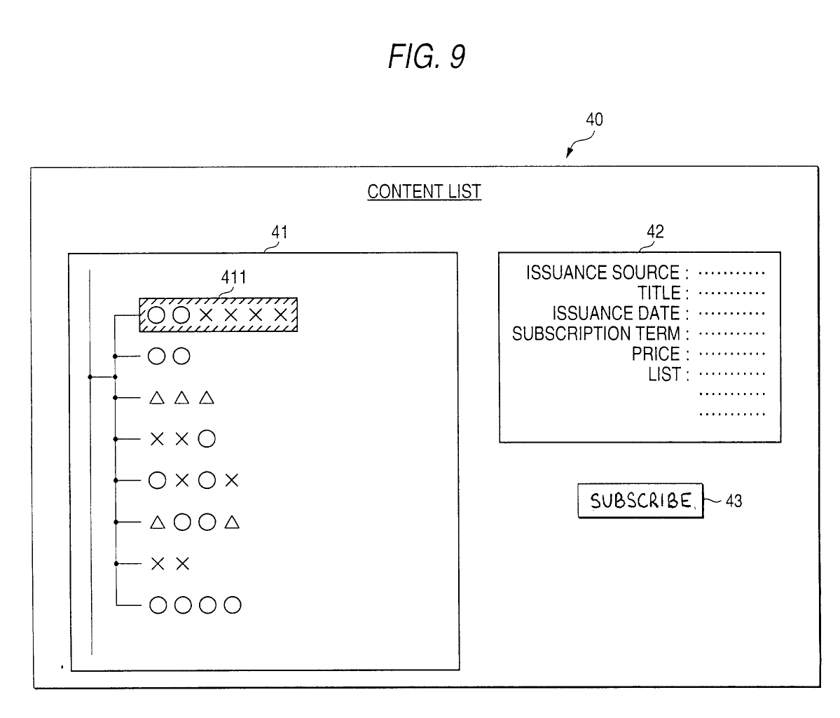

A content list screen 40 as shown in FIG. 9 is displayed on the display of the user terminal 30 receiving the screen data of the content list by the content managing software (SU109). As shown in FIG. 9, the content list screen 40 contains a list 41 of titles 411 of user-available contents, an information box 42 in which information on the contents (publishing sources, titles, issuance dates, subscription terms, prices, lists of contents) are displayed, and a click button displayed as “subscribe” (subscribe button) 43. The title 411 in the list 41 is clickable, and the information of the content associated with the title 411 clicked by a mouse or pointer can be displayed in the information box 42.

When the user selects a desired title 411 in the list 41 by using the mouse or pointer of the user terminal 30 and clicks the subscribe button 43, the content ID associated with the title 411 thus selected is transmitted to the authenticating server 10 from the user terminal 30 (SU110).

The main controller 11 of the authenticating server 10 receives the content ID (SA109), searches for the property information associated with the content ID thus received in the property information database 143 (SA110), and transmits the property information thus retrieved to the user terminal 30 together with the user ID of the user concerned (SA111). The property information contains information on the IP address of the content corresponding to the content ID in the content server 20 serving as a supply source, the access time for the content server 20, the expiration date of the property information concerned and the publisher of the content.

The user terminal 30 receives/stores the property information and the user ID, and checks whether the user ID is the true user ID of the user concerned (SU111). If it is acknowledged that the user ID is the true user ID of the user concerned, the user terminal 30 transmits the acknowledgement information to the authenticating server 10 (SU112). Thereafter, the user terminal 30 sets the content managing software to download the content on the basis of the property information thus received (SU113).

The main controller 11 of the authenticating server 10 receives the acknowledgement information (SA112), and stores the content ID in connection with the user ID of the user concerned in the user information database 145 (SA113). It is assumed that the charging process can be performed based on the information stored in the user information database 145 and the information stored in the content information database 144 in the authenticating server 10.

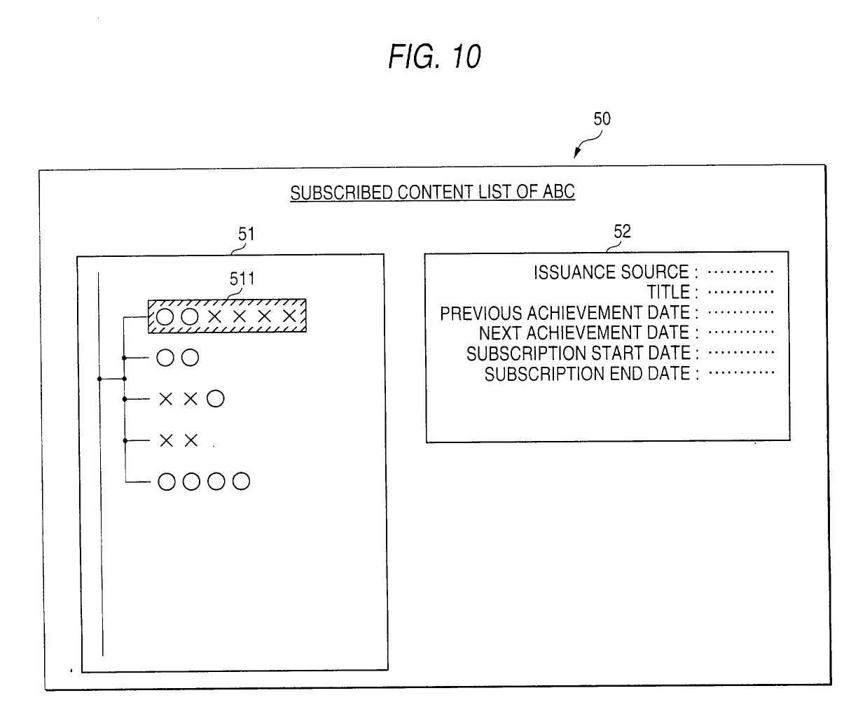

In the content managing software set according to the property information, a subscribed content list screen 50 which shows the contents subscribed to by the user concerned can be displayed in response to a request from the user, as shown in FIG. 10. The data of the subscribed content list screen 50 can be retrieved from the authenticating server 10 (the user information database 145/the content information database 144).

As shown in FIG. 10, the subscribed content list screen 50 contains a list 51 of the titles 511 of contents subscribed to by the user and an information box 52 in which information on the contents (publishing sources, titles, previous achievement dates, next achievement dates, subscription starting dates, subscription end dates) is displayed. The title 511 in the list 51 is clickable, and information of the content corresponding to the title 511 clicked by a mouse or pointer is displayed in the information box 52.

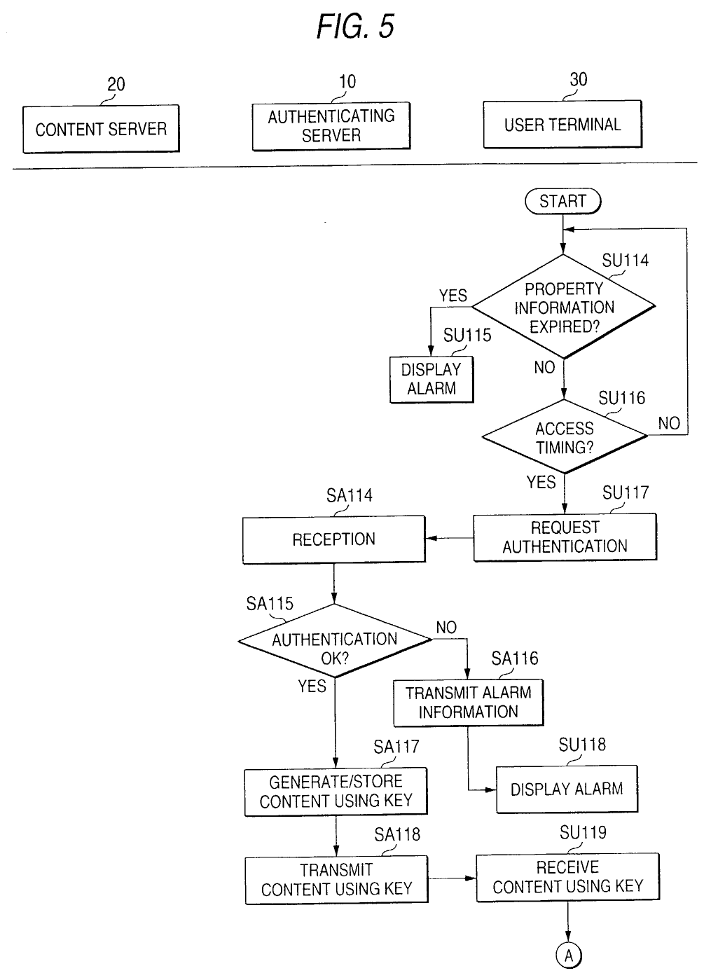

Next, the processing operation of the authenticating server 10, the content server 20 and the user terminal 30 when a content is downloaded on the basis of property information will be described (FIGS. 5 to 8).

The user terminal 30 in which the content managing software is set determines whether the expiration date of the property information has passed (SU114). If it is determined that the expiration date has passed, the user terminal 30 displays an alarm such as “Expiration date of property information has passed” on the display of the user terminal 30 (SU115). On the other hand, if it is determined that the expiration date of the property information has not passed, the user terminal 30 determines whether the present time is the access time to the content server 20 (SU116). If it is determined that the present time is the access time, the user terminal 30 transmits request information containing the user ID and the content ID to the authenticating server 10 (SU117).

The main controller 11 of the authenticating server 10 receives the request information for authentication (SA114), and refers to the user information database 145 to perform authentication (SA115). If the authentication is not properly completed, the main controller 11 of the authenticating server 10 transmits alarm information to the user terminal 30 (SA116), and alarm information such as “authentication has not been properly completed” is displayed on the display of the user terminal 30 receiving the alarm information from the main controller 11 (SU118).

When the authentication has been properly completed, the main controller 11 of the authenticating server 10 generates a unique content using key and stores it in association with the user ID of the user concerned (SA117), and transmits the content using key to the user terminal 30 (SA118).

When receiving the content using key (SU119), the user terminal 30 transmits download request information containing the user ID, the content using key and information on the previous download date of the content concerned to the content server 20 set in the content managing software (SU120).

The main controller of the content server 20 receives the download request information (SC101), and transmits acknowledgement request information for the user ID and the content using key thus received to the authenticating server 10 (SC102). The main controller 11 of the authenticating server 10 receives the acknowledgement request information containing the user ID and the content using key (SA119), and determines whether the user ID and the content using key thus received are coincident with the user ID and the content using key stored in step SA117. If it is determined that they are coincident with each other, the main controller 11 of the authenticating server 10 transmits content using key acknowledgement information to the content server 20 (SA120).

When receiving the content using key acknowledgement information (SC103), the main controller of the content server 20 searches for the content to be transmitted (SC104), and transmits it to the user terminal 30 (SC105). At the header of the content (electronic publication) are described the user ID, publisher property, the content detailed ID, a viewer identifier for display, a viewer achieving server address for display, the expiration date of the content concerned, the data size of the content concerned, etc.

When the content server 20 searches for the content, the content server 20 can specify the latest content to be transmitted to the user concerned on the basis of the previous download date received by the content server 20 in step SC101.

When receiving (downloading) the content (SU121), the user terminal 30 determines whether the data size of the content thus downloaded is coincident with the data size described at the header of the content (SU122). If they are not coincident with each other, the user terminal 30 returns to step SU120 to request download again.

If it is determined that the data size downloaded is coincident with the data size described at the header, the user terminal 30 determines whether the user ID described at the header of the content thus downloaded is coincident with the user ID (set in the content managing software) of the user concerned (SU123). If they are not coincident with each other, the user terminal 30 returns to step SU120 to request download again.

When it is determined that the user ID described at the header of the content is correct, the user terminal 30 determines whether the content detailed ID described at the header of the content differs from the content detailed ID of the past-downloaded content, that is, whether the content detailed ID described at the header of the content is new (SU124).

If it is determined that the content detailed ID described at the header of the content is new, the user terminal 30 adds the title of the content to the downloaded content list, and also a flag for new-arrived information is put in the title concerned (SU125). The user terminal 30 stores in the content managing software the day on which the content is downloaded.

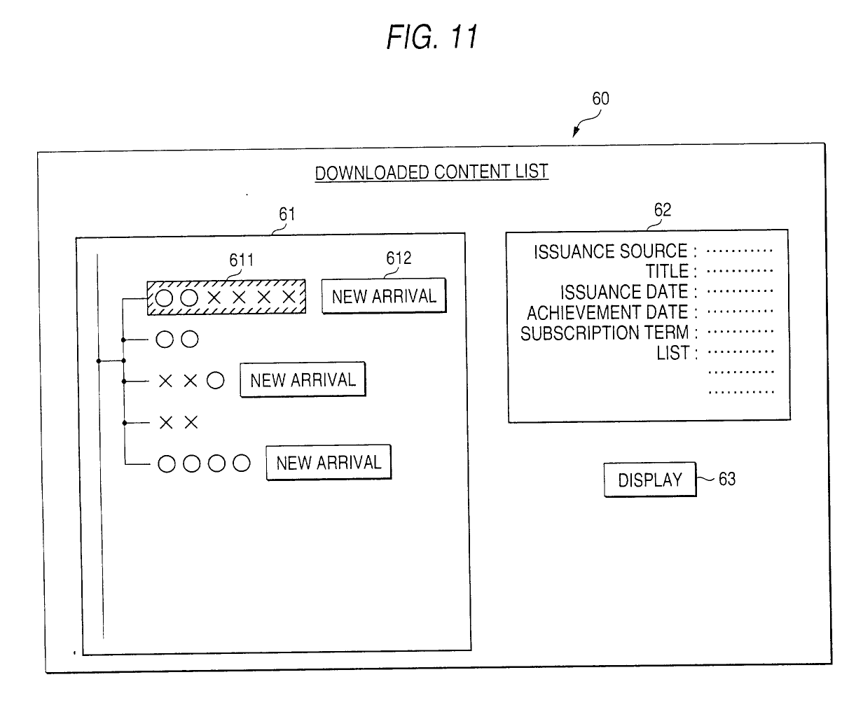

As described above, with the content managing software downloading the content, the downloaded content list screen 60 shown in FIG. 11 is displayed in response to a request from the user. The downloaded content list screen 60 may be created on the basis of the information stored in the content managing software or achieved from the authenticating server 10 (user information database 145/content information database 144).

As shown in FIG. 11, the downloaded content list screen 60 contains a list 61 of the titles 611 of downloaded contents, an information box 62 in which the information on the contents (publishing sources, titles, issuance dates, achieving dates, subscription terms, lists of contents) are displayed, and a click button (display button) 63 indicated as “display”. The titles 611 in the list 61 are clickable, and the information on the content corresponding to a title 611 clicked by a mouse or pointer is displayed in the information box 62. Further, in the list 61, newly-arrived information 612 indicated as “new arrival” is added beside the titles 611 of contents which have not yet been displayed.

On the basis of the expiration date described at the header of a content, the user terminal 30 downloading the content determines whether the expiration date of the content has passed (SU126). If it is determined that the expiration date has passed, an alarm such as “Expiration date of content has passed” or the like is displayed on the display of the user terminal 30 so that the content concerned is prevented from being displayed (SU127).

If it is determined that the expiration date of the content has not passed, the user terminal 30 determines whether a display request for the content has been made by clicking the display button 63 on the downloaded content list screen 60 (SU128).

If it is determined that a display request for the content has been made, the user terminal 30 determines whether the viewer corresponding to the viewer identifier for display described at the header of the content concerned exists in the hard disc of the user terminal 30 (SU129).

If it is determined that the viewer exists, the user terminal 30 starts the viewer (SU130) and displays the content (SU131). Thereafter, the flag of the newly-arrived information put in the title of the content concerned is deleted (SU132).

On the other hand, if it is determined that the viewer does not exist, the user terminal 30 reads out the display viewer achieving server address described at the header of the content concerned (SU133), and transmits the download request information for the viewer to the server corresponding to the address (SU134). In this embodiment, the display viewer achieving server address is the same as the IP address of the content server 20, however, the present invention is not limited to this embodiment.

The main controller of the content server 20 receives the download request information (SC106), and transmits the data of the viewer to the user terminal 30 (SC107). The user terminal 30 receives (downloads) the data of the viewer (SU135), and installs the viewer concerned (SU136). The subsequent processing operation is the same as the steps SU130 to SU132. As described above, high-quality contents can be supplied by using dedicated viewers for the respective contents.

In the content distributing system described above, the property information of the content is provided for every content. Therefore, the information on the download of the content can be set in detail for every content by the property information. The user can automatically achieve a desired content by installing the property information in the content managing software of the user terminal 30, and thus the user is not required to set the time of the download, etc. by himself/herself. Furthermore, the content supplier can set the download time at the user's convenience. Therefore, concentration of access to the content server 20 can be prevented and downloading before content renewal can be prevented.

According to the content distributing system, authenticating business/charging business for each content server 20 can be collectively performed in the authenticating server 10. Furthermore, by providing the authenticating server 10, the content servers 20 can be dispersed and a content server 20 can be set for each content, so that the loads imposed on each content server 20 can be reduced.

The embodiment described above has been described to make the present invention easily understandable, however, the present invention is not limited to the above embodiment. Accordingly, the respective elements disclosed in the above embodiment may contain all the design modifications and equivalents belonging to the subject matter of the present invention.

For example, the content managing software may have a power managing function of setting the power source of the user terminal 30 to an active state just before the access time to the content server 20 comes and setting the power source of the user terminal 30 to a non-active state when the content download is finished.

As described above, according to the present invention, when a user retrieves a desired content, the user is not required to set the time of the download of the content by himself/herself.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A recording medium recorded with a computer program for downloading content, the program comprising:
displaying a list of usable contents from which a user may select a desired content;
retrieving from a prescribed computer property information including an address of a content server for supplying the selected content and an access time for the content server;
accessing the content server at a prescribed time based on the property information to download the selected content; and
informing the user that the selected content has been downloaded.

2. The recording medium as claimed in claim 1, wherein the program further comprises:
retrieving authentication information from the prescribed computer; and
transmitting the retrieved authentication information when the content server is accessed at the prescribed time.

3. The recording medium as claimed in claim 1, wherein the property information further includes an expiration date of the property information, the program further comprising:
determining whether the expiration date of the property information has passed; and
informing the user that the property information has expired when it is determined that the expiration date of the property information has passed.

4. The recording medium as claimed in claim 1, wherein the selected content includes an expiration date of the selected content, the program further comprising:
determining whether the expiration date of the selected content has passed; and
informing the user that the selected content has expired when it is determined that the expiration date of the selected content has passed.

5. The recording medium as claimed in claim 1, wherein the selected content includes an address of another server for supplying software needed to display the selected content, the program further comprising:
accessing the address of the another server and downloading the software.

6. The recording medium as claimed in any one of claims 1 to 5, wherein the program further comprises:
storing a download time when the selected content has been downloaded; and
transmitting information on a previous download time of the selected content when the content server is accessed at the prescribed time.

7. A client computer, comprising:
means for displaying a list of usable contents from which a user may select a desired content;
means for retrieving from a prescribed computer property information including an address of a content server for supplying the selected content and an access time for the content server;
means for accessing the content server at a prescribed time based on the property information to download the selected content; and
means for informing the user that the selected content has been downloaded.

8. The client computer as claimed in claim 7, further comprising:
means for retrieving authentication information from the prescribed computer; and
means for transmitting the retrieved authentication information when the content server is accessed at the prescribed time.

9. The client computer as claimed in claim 7, wherein the property information further includes an expiration date of the property information, the client computer further comprising:
means for determining whether the expiration date of the property information has passed, and for informing the user that the property information has expired when it is determined that the expiration date of the property information has passed.

10. The client computer as claimed in claim 7, wherein the selected content includes an expiration date of the selected content, the client computer further comprising:
means for determining whether the expiration date of the selected content has passed, and for informing the user that the selected content has expired when it is determined that the expiration date of the selected content has passed.

11. The client computer as claimed in claim 7, wherein the selected content includes an address of another server for supplying software needed to display the selected content, the client computer further comprising:
means for determining whether the software needed to display the selected content exists in the client computer; and
means for accessing the address of the another server and for downloading the software if it is determined that the software does not exist in the client computer.

12. The client computer as claimed in any one of claims 7 to 11, further comprising:
means for storing a download time of the selected content; and
means for transmitting information on a previous download time of the selected content when the content server is accessed at the prescribed time.

13. A server, comprising:
means for storing property information associated with each of a plurality of contents, the property information including an address of a content server for supplying the respective content and an access time for the content server; and
means for transmitting to a client computer the property information associated with a specified one of the plurality of contents requested by the client computer.

14. The server as claimed in claim 13, further comprising:
means for generating and holding authentication information;
means for transmitting the generated authentication information to the client computer; and
means for receiving second authentication information from the content server and for performing an authentication process based on the second authentication information.

15. The server as claimed in claim 13, further comprising:
means for storing, in association with user identification information, identification information for a user-usable content relating to the user identification information.

16. The server as claimed in any one of claims 13 to 15, further comprising:
means for storing a computer program for downloading content, the program including:
displaying a list of usable contents from which a user may select a desired content;
retrieving from the server the property information associated with the specified one of the plurality of contents;
accessing the content server at a prescribed time based on the property information associated with the specified one of the plurality of contents to download the selected content; and
informing the user that the selected content has been downloaded.

17. A server, comprising:
means for receiving authentication information when a request for a specified content is received from a client computer;
means for transmitting the received authentication information to a prescribed computer and for receiving a result of an authentication process carried out in the prescribed computer; and
means for transmitting the specified content to the client computer only when the result of the authentication process indicates authenticity.

18. A server, comprising:
means for receiving a request for a specified content from a client computer; and
means for transmitting to the client computer an address of another server for supplying software needed to display the specified content together with the specified content.

19. A server, comprising:
means for receiving information on a previous download time of a specified content when a request for the specified content is received from a client computer;
means for selecting a content to be transmitted to the client computer based on the information on the previous download time; and
means for transmitting the selected content to the client computer.

20. A content distributing system, comprising:
a client computer;
a server; and
a communication network for connecting said client computer to said server;
said client computer including:
means for displaying a list of usable contents from which a user may select a desired content;
means for retrieving from the server property information including an address of a content server for supplying the selected content and an access time for the content server;
means for accessing the content server at a prescribed time based on the property information to download the selected content; and
means for informing the user that the selected content has been downloaded; and
the server including:
means for storing the property information associated with each of the contents; and
means for transmitting to the client computer the property information associated with the selected content.

21. A method of distributing a content from a content server through a communication network to a client computer, comprising:
displaying a list of usable contents at the client computer from which a user may select a desired content;
transmitting property information from a prescribed computer to the client computer, the property information including an address of the content server for supplying the selected content and an access time for the content server; and
accessing the content server at a prescribed time based on the property information and downloading the selected content to the client computer.

22. The content distributing method as claimed in claim 21, further comprising:
generating and storing authentication information in the prescribed computer;
transmitting the generated authentication information from the prescribed computer to the client computer;
transmitting the authentication information received at the client computer from the client computer to the content server;
transmitting the authentication information received at the content server from the content server to the prescribed computer;
performing an authentication process based on the authentication information received at the prescribed computer to obtain an authentication result;
transmitting the authentication result from the prescribed computer to the content server; and
transmitting the selected content from the content server to the client computer based on the authentication result.

23. The content distributing method as claimed in claim 21, wherein the property information further includes an expiration date of the property information, said content distributing method further comprising:
determining whether the expiration date of the property information has passed; and
informing the user that the property information has expired when it is determined that the expiration date of the property information has passed.

24. The content distributing method as claimed in claim 21, wherein the selected content includes an expiration date of the selected content, said content distributing method further comprising:
determining whether the expiration date of the selected content has passed; and
informing the user that the selected content has expired when it is determined that the expiration date of the selected content has passed.

25. The content distributing method as claimed in claim 21, wherein the selected content includes an address of another server for supplying software needed to display the selected content, said content distributing method further comprising:
determining whether the software needed to display the selected content exists in the client computer; and
accessing the address of the another server and downloading the software if it is determined that the software does not exist in the client computer.

26. The content distributing method as claimed in any one of claims 21 to 25, further comprising:
storing a download time of the selected content in the client computer;
transmitting information on the stored download time from the client computer to the content server;
identifying a content to be transmitted to the client computer based on the information on the stored download time received in the content server; and
transmitting the identified content to the client computer.
